(19) United States
(12) Patent Application Publication
(10) Pub. No.: US 2020/0319392 A1
(43) Pub. Date: Oct. 8, 2020

(54) LIGHT-GUIDING PLATE, BACKLIGHT DEVICE, AND DISPLAY APPARATUS

(71) Applicant: SHARP KABUSHIKI KAISHA, Sakai City (JP)

(72) Inventor: NOZOMU KOHSAKA, Sakai City (JP)

(21) Appl. No.: 16/838,742

(22) Filed: Apr. 2, 2020

Related U.S. Application Data
(60) Provisional application No. 62/829,480, filed on Apr. 4, 2019.

(51) Int. Cl. F21V 8/00

(52) U.S. Cl. CPC G02B 6/0045; G02B 6/0055

(57) ABSTRACT

A light-guiding plate includes a flat first end surface; a flat first plate surface; a second plate surface as a plate surface positioned opposite the first plate surface; and a second end surface different from the first end surface and including an upright surface extending upward from the second plate surface, and a sloping surface forming a surface sloping inward from the upright surface to the first plate surface.

### BACKGROUND OF THE INVENTION

### Field of the Invention

The present invention relates to a light-guiding plate that receives light at a side surface thereof and emits the light from a front surface thereof, a backlight device including the light-guiding plate, and a display apparatus including the backlight device.

### Description of the Background Art

Some of liquid crystal display apparatuses may include light-guiding plates that cause light received from light sources to be efficiently propagated toward display panels. A light-guiding plate has an entrance surface from which light coming from a light source enters, an exit surface from which the light entered from the entrance surface exits toward a display panel, and a reflective surface positioned opposite the exit surface. The light received from the light source is repeatedly reflected within the light-guiding plate and exits from the exit surface to be supplied to the display panel. Part of the light reflected within the light-guiding plate may also exits from, for example, side surfaces of the light-guiding plate. There is a known technique for efficiently emitting the light from the exit surface in which reflective sheets or the like are provided on side surfaces, whereby the light that is about to exit from the side surfaces is redirected toward the inside of the light-guiding plate (Japanese Unexamined Patent Application Publication No. 2017-204370).

### SUMMARY

In recent years, however, there has been a demand for display apparatuses with narrower frames. In some cases, the dimensional ratio of a non-display area provided on the outer periphery of the display panel to a display area is designed to be small. In such a case, as illustrated in FIG. 7A, if a reflective sheet 291 is provided on a surface opposite a light source or on a side surface of a light-guiding plate 280, light propagated in the light-guiding plate 280 and light reflected by the reflective sheet 291 gather near the side surface of the light-guiding plate enclosed by a two-dot chain line. Consequently, as illustrated in FIG. 7B, the brightness in the display area of a backlight device 200 may vary between a central part CR and a peripheral part ER, causing luminance nonuniformity.

One aspect of the present invention has been conceived in view of the above problem. An object of the present invention is to provide a light-guiding plate that efficiently emits light received from a light source and does not cause luminance nonuniformity over the entirety of a display panel, a backlight device including the light-guiding plate, and a display apparatus including the backlight device.

(1) An embodiment of the present invention provides a light-guiding plate that includes a flat first end surface; a flat first plate surface; a second plate surface as a plate surface positioned opposite the first plate surface; and a second end surface different from the first end surface and including an upright surface extending upward from the second plate surface, and a sloping surface forming a surface sloping inward from the upright surface to the first plate surface.

(2) Another embodiment of the present invention provides a light-guiding plate in which, in addition to the above configuration (1), the upright surface extends perpendicularly to the second plate surface, and an angle formed between the upright surface and the sloping surface is an obtuse angle.

(3) Yet another embodiment of the present invention provides a light-guiding plate in which, in addition to the above configuration (1) or (2), the second end surface is provided with a reflective member.

(4) Yet another embodiment of the present invention provides a light-guiding plate in which, in addition to the above configuration (3), the reflective member is any of a metal reflective sheet, a resin reflective sheet, and reflective paint.

(5) Yet another embodiment of the present invention provides a backlight device that includes the light-guiding plate according to any of the above (1) to (4), a light source, and a housing that houses the light-guiding plate and the light source.

(6) Yet another embodiment of the present invention provides a display apparatus that includes the backlight device according to the above (5), and a display panel that receives light from the backlight device.

According to one aspect of the present invention, a light-guiding plate that efficiently emits light received from a light source and does not cause luminance nonuniformity over the entirety of a display panel, a backlight device including the light-guiding plate, and a display apparatus including the backlight device can be obtained.

### BRIEF DESCRIPTION OF THE DRAWINGS

FIG. 1 is a schematic sectional view of a display apparatus according to an embodiment of the present invention;

FIG. 2 is a schematic plan view of a backlight device according to the embodiment of the present invention;

FIG. 3 is a sectional view taken along line A-A′ illustrated in FIG. 2;

FIG. 4 is a sectional view taken along line B-B′ illustrated in FIG. 2;

FIG. 5A is an enlarged view of relevant part of a light-guiding plate;

FIG. 5B is another enlarged view of relevant part of the light-guiding plate;

FIG. 6 is a diagram illustrating a luminance distribution in the backlight device according to the embodiment of the present invention;

FIG. 7A is an enlarged view of relevant part of a light-guiding plate according to a related art; and

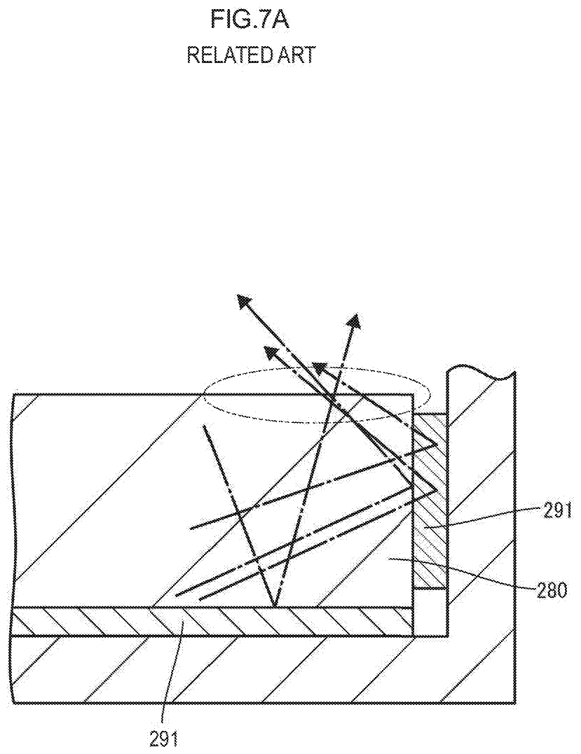

FIG. 7B is a diagram illustrating a luminance distribution in a backlight device according to the related art.

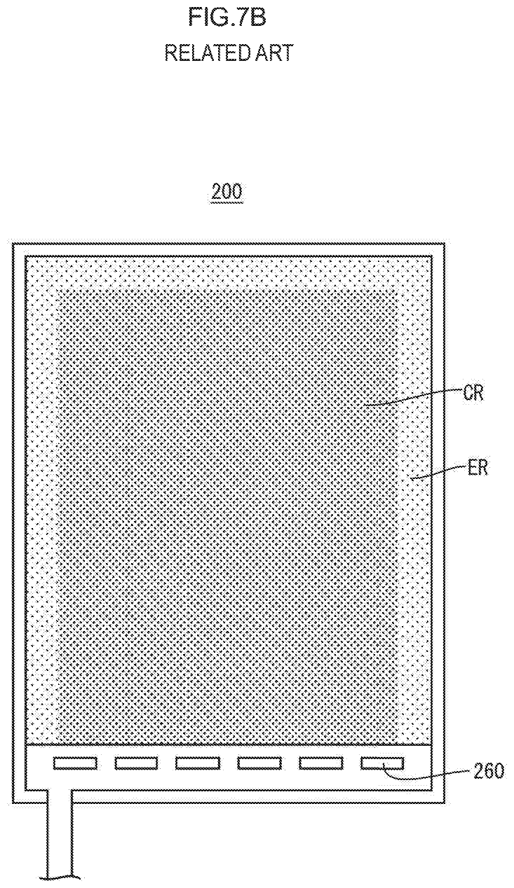

### DESCRIPTION OF THE PREFERRED EMBODIMENTS

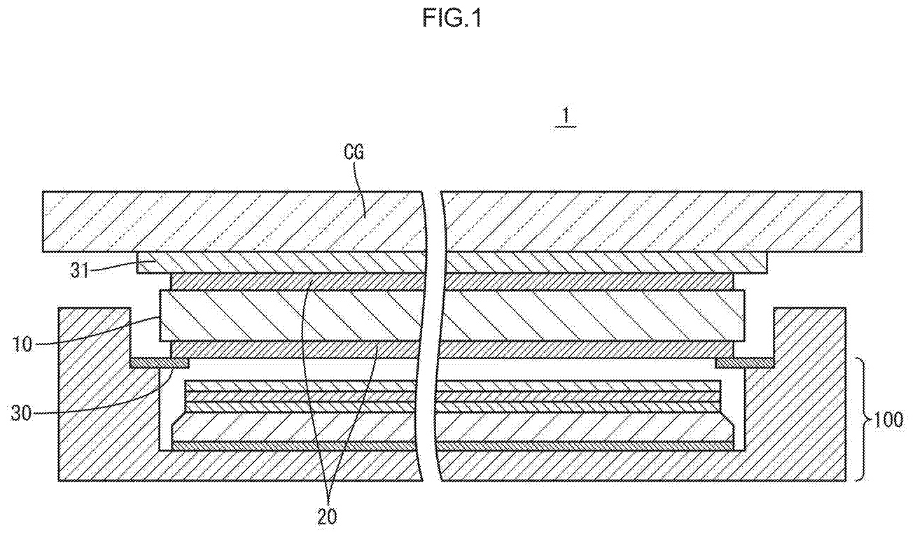

Referring to FIGS. 1 to 6, a light-guiding plate, a backlight device, and a display apparatus according to a present embodiment will now be described. A display apparatus 1 according to the present embodiment is used in, for example, information terminals such as laptop computers (including a tablet-type laptop computer and the like) and wearable terminals (including a smart watch and the like), and various electronic apparatuses such as game machines.

FIG. 1 is a schematic sectional view of the display apparatus 1 according to the present embodiment. The display apparatus 1 has a rectangular shape in plan view and includes a backlight device 100, a pair of polarizing plates 20, a display panel 10 held between the pair of polarizing plates 20, and a cover glass CG. Adhesive members 30 and 31 are provided between the backlight device 100 and one of the polarizing plates 20 and between the other of the polarizing plates 20 and the cover glass CG.

These elements are bonded to one another by using the adhesive members 30 and 31, thereby integrated into a unit.

The display panel 10 is obtained by pasting a pair of glass substrates to each other with a predetermined gap interposed therebetween and sealing a liquid crystal layer in the gap between the two glass substrates. The liquid crystal layer contains liquid crystal molecules having optical characteristics that change with the application of an electric field. The display panel 10 has a display surface on which an image is displayable at the reception of light from the backlight device 100. The cover glass CG, which protects the display panel 10, is provided on a side of the display panel 10 nearer to the display surface. The backlight device 100 is provided on a side of the display panel 10 farther from the display surface.

The cover glass CG extends over the entirety of the display surface of the display panel 10, thereby protecting the display panel 10. The cover glass CG is larger than the display panel 10 in plan view and is made of a plate-like glass base having excellent transparency. The cover glass CG is preferably made of chemically strengthened glass such as tempered glass. If tempered glass is employed, the mechanical strength and the shock resistance are increased. Therefore, the display panel 10 can be prevented from being damaged.

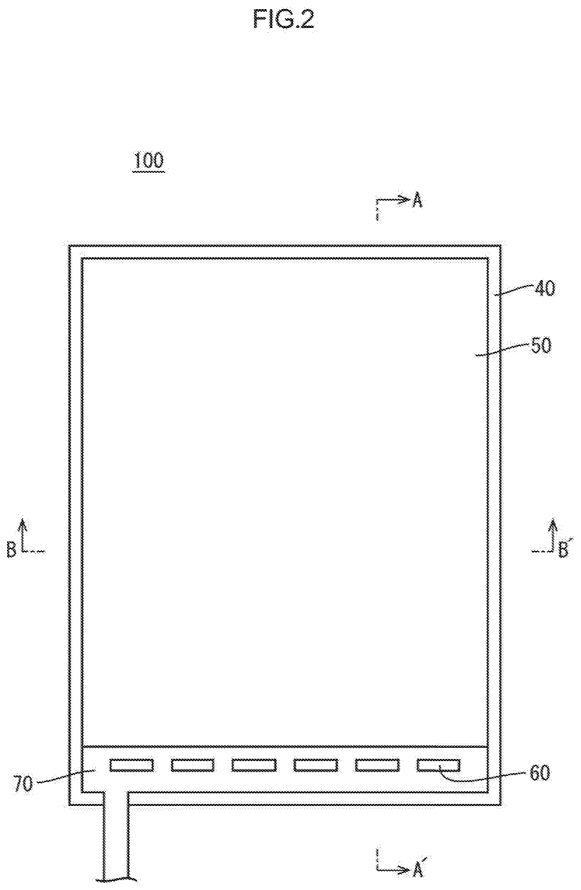

As illustrated in FIG. 2, the backlight device 100 has a rectangular shape as a whole in plan view and includes a light source 60, a circuit board 70, and an optical sheet 50. The light source 60, the circuit board 70, and the optical sheet 50 are collectively housed in a backlight chassis 40 (hereinafter simply referred to as chassis), which is a housing. The light source 60 is positioned on one side of the backlight device 100 and is connected to an external terminal through the circuit board 70. The light source 60 may be selected from, for example, a cold-cathode tube, an LED, and the like. In particular, an LED is preferable.

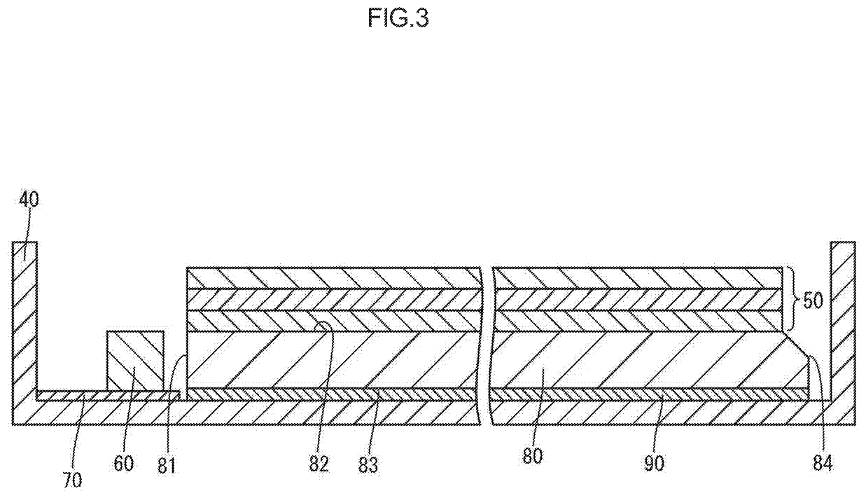

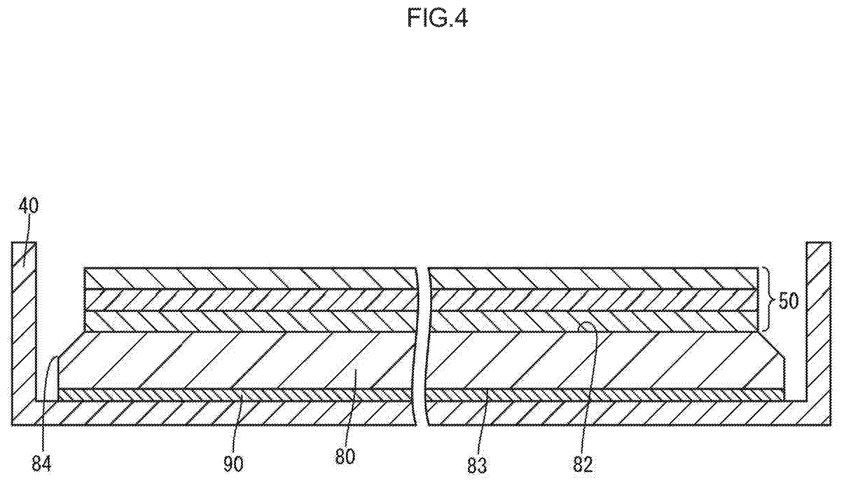

FIG. 3 is a sectional view of the backlight device 100 taken along line A-A′. FIG. 4 is a sectional view of the backlight device 100 taken along line B-B′. Referring to FIGS. 2 and 3, the chassis 40 further houses a light-guiding plate 80 and a reflective sheet 90. The chassis 40 is made of synthetic resin. The chassis 40 is a little larger than the display panel 10 in plan view and has a substantially box-like shape that is open toward the display panel 10. The shape of the chassis 40 is not limited to that illustrated in FIGS. 3 and 4. The chassis 40 may have a shape formed as a combination of a lower chassis and an upper chassis, and the polarizing plates 20 and the display panel 10 may be bonded to the upper chassis. The shape of the chassis 40 may be selected according to need.

The light-guiding plate 80 has an entrance surface 81 facing the light source 60 and from which light coming from the light source 60 enters, an exit surface 82 from which the light entered from the light source 60 exits, and a first reflective surface 83 and a second reflective surface 84 that reflect the light entered from the light source 60. The first reflective surface 83 is a surface opposite the exit surface 82. The second reflective surface 84 is a surface at a different position from the first reflective surface 83 and has a cutout. Accordingly, the second reflective surface 84 is a surface opposite (a surface parallel to) the entrance surface 81 in FIG. 3 and is a surface perpendicular to the entrance surface 81 in FIG. 4. In other words, referring to FIG. 2, the three sides on which the light source 60 is not provided each correspond to the second reflective surface 84.

The first plate surface (exit surface) 82 and the optical sheet 50 face each other, and the second plate surface (first reflective surface) 83 and the reflective sheet 90 face each other. In such an arrangement, the light entered from the first end surface (entrance surface) 81 travels through the light-guiding plate 80 while being reflected by the reflective sheet 90 provided on a side nearer to the second plate surface 83, and exits from the first plate surface (exit surface) 82. Then, the light enters the optical sheet 50. The optical sheet 50 includes a plurality of sheets (three sheets in FIGS. 3 and 4), such as lens sheets and prism sheets, having a diffusing function and is capable of causing the light entered from the first plate surface (exit surface) 82 to be efficiently diffused before entering the display panel 10.

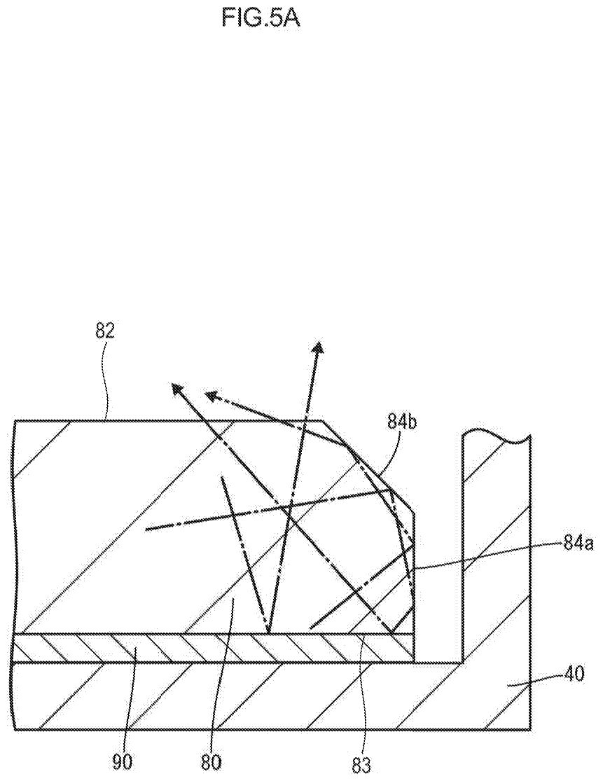

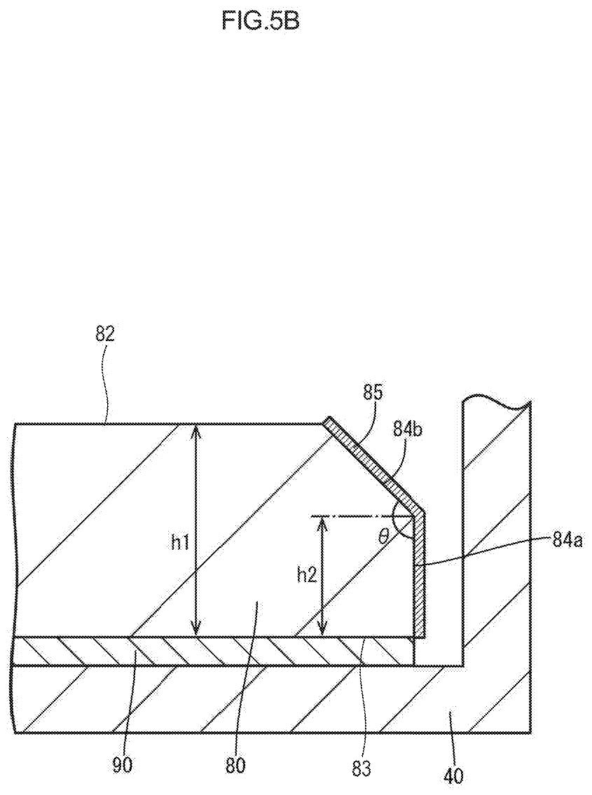

Referring to FIGS. 5A and 5B, a configuration of the second end surface (second reflective surface) 84 will now be described. The second end surface 84 includes an upright surface 84a forming a surface extending upward from and perpendicularly to the second plate surface 83, and a sloping surface 84b forming a surface sloping inward from the upright surface 84a to the first plate surface 82. The upright surface 84a is a surface positioned on a side of the light-guiding plate 80 that is nearer to the second plate surface 83 in the thickness direction of the light-guiding plate 80. The sloping surface 84b is a surface positioned on a side nearer to the first plate surface (exit surface) 82 in the thickness direction of the light-guiding plate 80. Note that the sloping surface 84b may also be regarded as a cut-off portion obtained by cutting off a corner of the light-guiding plate, which is a cuboid. The light entered from the first end surface (entrance surface) 81 is reflected by edges of the light-guiding plate 80, various surfaces of the light-guiding plate 80, and so forth and then exits from the first plate surface (exit surface) 82. If the light-guiding plate 80 has the sloping surface 84b, the light entered from the first end surface (entrance surface) 81 is reflected by the sloping surface 84b. Then, the light exits from part of the first plate surface (exit surface) 82 that is nearer to the center. The second end surface 84 includes the upright surface 84a and the sloping surface 84b. Therefore, when the light entered from the first end surface (entrance surface) 81 strikes the second end surface 84, the reflection angle of the light can be changed. Hence, the reflection path of the light tends to be defined more randomly. Thus, the light exiting from the first plate surface (exit surface) 82 can be prevented from gathering near a peripheral area of the light-guiding plate 80, i.e., near a peripheral area of the display panel 10. Furthermore, even if some light leaks from the second end surface 84 and re-enters the light-guiding plate 80, the path of the light thus entered can be changed because the second end surface 84 includes the sloping surface 84b. Therefore, light can be emitted from the entirety of the first plate surface (exit surface) 82. Furthermore, the sloping surface 84b only needs to be included in at least the second end surface 84. The sloping surface 84b is included in any of the end surfaces other than the first end surface (entrance surface) 81 according to need and may be included in each of all the end surfaces excluding the first end surface (entrance surface) 81.

It is preferable that an angle θ formed between the upright surface 84a and the sloping surface 84b be an obtuse angle. If the angle θ formed between the upright surface 84a and the sloping surface 84b is an obtuse angle, light can be efficiently emitted from the first plate surface (exit surface) 82 without extremely reducing the area of the first plate surface (exit surface) 82 of the light-guiding plate 80. Defining a height h1 of the light-guiding plate 80 as 1, the ratio between the height h1 of the light-guiding plate 80 and a height h2 of the upright surface 84a may be set such that the height h2 of the upright surface 84a becomes 0.3 or greater and 0.9 or smaller, preferably, 0.5 or greater and 0.8 or smaller. Defining the height h1 of the light-guiding plate 80 as 1, if the height h2 of the first reflective area 84a is 0.3 or greater and 0.9 or smaller, light can be efficiently emitted from the first plate surface (exit surface) 82 without making the contour of the light-guiding plate 80 extremely larger than the contour of the display panel 10.

In addition, a reflective member 85 may be provided on the second end surface 84 in such a manner as to cover the upright surface 84a and the sloping surface 84b. Providing the reflective member 85 can prevent light from exiting through the second end surface 84. Therefore, light can be utilized more efficiently.

The reflective member 85 may be the same as or different from the reflective sheet 90. Specifically, a metal reflective sheet, a resin reflective sheet, reflective paint, or the like may be employed according to need.

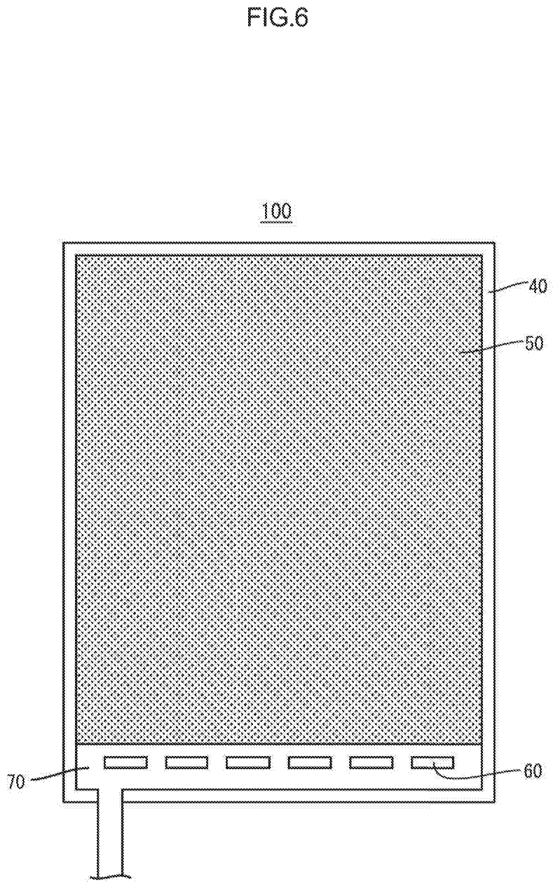

In the light-guiding plate 80 according to the present embodiment, the light received from the light source 60 can be efficiently emitted from the first plate surface (exit surface) 82 without making the light-guiding plate 80 larger than the display panel 10. Consequently, as illustrated in FIG. 6, the light emitted from the first plate surface (exit surface) 82 is not distributed unevenly. Therefore, an image can be displayed with even brightness. Furthermore, the display apparatus 1 can be manufactured without making the light-guiding plate 80 extremely larger than the display panel 10.

What is claimed is:

1. A light-guiding plate comprising:
a flat first end surface;
a flat first plate surface;
a second plate surface as a plate surface positioned opposite the first plate surface; and
a second end surface different from the first end surface and including an upright surface extending upward from the second plate surface, and a sloping surface forming a surface sloping inward from the upright surface to the first plate surface.

2. The light-guiding plate according to claim 1,
wherein the upright surface extends perpendicularly to the second plate surface, and
wherein an angle formed between the upright surface and the sloping surface is an obtuse angle.

3. The light-guiding plate according to claim 1, wherein the second end surface is provided with a reflective member.

4. The light-guiding plate according to claim 3, wherein the reflective member is any of a metal reflective sheet, a resin reflective sheet, and reflective paint.

5. A backlight device comprising:
the light-guiding plate according to claim 1;
a light source; and
a housing that houses the light-guiding plate and the light source.

6. A display apparatus comprising:
the backlight device according to claim 5; and
a display panel that receives light from the backlight device.
